(19) United States
(12) Patent Application Publication
(10) Pub. No.: US 2025/0371415 A1
(43) Pub. Date: Dec. 4, 2025

(54) Distributed Execution of a Machine-Learning Model on a Server Cluster

(71) Applicant: Visa International Service Association, San Francisco, CA (US)

(72) Inventors: Harishkumar Sundarji Majithiya, Austin, TX (US); Sugandh Sachdev, Austin, TX (US)

(21) Appl. No.: 18/873,423

(22) PCT Filed: Jun. 16, 2022
(86) PCT No.: PCT/US2022/033706

§ 371 Date: Dec. 10, 2024

(51) Int. Cl. G06N 20/00

(52) U.S. Cl. CPC G06N 20/00

(57) ABSTRACT

Described are a system, method, and computer program product for distributed execution of a machine-learning model on a server cluster. The method includes initiating retrieval of a machine-learning model from a data repository and converting the machine-learning model to an executable format. The method includes transmitting the converted machine-learning model to each node of the server cluster and executing the converted machine-learning model on each node. The method includes generating an initial performance metric based on execution of the converted machine-learning model on each node. The method includes transmitting the plurality of initial performance metrics from each node to an external processor and combining the plurality of initial performance metrics to produce a combined performance metric. The method includes modifying a model hyperparameter of the machine-learning model based on the combined performance metric and executing the modified machine-learning model in a computer system to evaluate real-time event data.

### CROSS-REFERENCE TO RELATED APPLICATION

This application is the United States national phase of International Patent Application No. PCT/US22/33706 filed Jun. 16, 2022, the disclosure of which is hereby incorporated by reference in its entirety.

### BACKGROUND

### 1. Technical Field

This disclosure relates generally to machine-learning model execution and, in non-limiting embodiments or aspects, to systems, methods, and computer program products for distributed execution of a machine-learning model on a server cluster.

### 2. Technical Considerations

Deployment of machine-learning models is an ever-changing challenge in a world that demands accurate, well-trained, and on-demand results. Machine-learning models may need to be trained with large quantities (e.g., petabytes) of historical data before being deployed in a production environment. High-performing machine-learning models may be required to be resilient to changes in patterns based on time, e.g., seasonality, which may increase training data requirements. When assembling a machine-learning model for execution in a production environment, multiple machine-learning models may need to be tested to determine the best-performing model. If the above processes are performed by a single computer, the large quantities of historical data would need to be retrieved from storage for training and/or execution of the machine-learning model, which would consume proportionally large quantities of processing time. Furthermore, in a networked system, transmitting large quantities of historical data to the machine-learning model may consume significant bandwidth and would slow the entire process from training to evaluation to execution.

Accordingly, there is a need in the art for a technical solution that resolves the problems of transmitting stored data to a machine-learning model for training, testing, and the like, and that provides for faster development-to-implementation workflows while also reducing computer resource requirements.

### SUMMARY

Accordingly, provided are improved systems, methods, and computer program products for distributed execution of a machine-learning model on a server cluster.

According to some non-limiting embodiments or aspects, provided is a computer-implemented method for distributed execution of a machine-learning model on a server cluster. The method includes receiving, with at least one processor, a request identifying at least one machine-learning model. The method also includes initiating retrieval, with at least one processor, of the at least one machine-learning model from a data repository based on the request. The method further includes converting, with at least one processor, the at least one machine-learning model from an initial format to an executable format compatible with distributed execution on a server cluster, to produce at least one converted machine-learning model. The method further includes transmitting, with at least one processor, the at least one converted machine-learning model to each node of at least two nodes of the server cluster. The method further includes executing, with at least one processor, the at least one converted machine-learning model on each node of the at least two nodes using data stored on said each node. The method further includes generating, with at least one processor, an initial performance metric on each node of the at least two nodes based on execution of the at least one converted machine-learning model on each node of the at least two nodes, to produce a plurality of initial performance metrics. The method further includes transmitting, with at least one processor, the plurality of initial performance metrics from each node of the at least two nodes to a processor external to the server cluster. The method further includes combining, with at least one processor, the plurality of initial performance metrics to produce at least one combined performance metric for the at least one converted machine-learning model. The method further includes modifying, with at least one processor, at least one model hyperparameter of the at least one machine-learning model based on the at least one combined performance metric, to produce at least one modified machine-learning model. The method further includes executing, with at least one processor, the at least one modified machine-learning model in a computer system to evaluate real-time event data.

In some non-limiting embodiments or aspects, the request may include at least one data parameter associated with a subset of data stored in the server cluster. Executing the at least one converted machine-learning model on each node of the at least two nodes further may include inputting the subset of data stored on said each node to the at least one converted machine-learning model based on the at least one data parameter.

In some non-limiting embodiments or aspects, converting the at least one machine-learning model to the executable format compatible with distributed execution in the server cluster may include converting, with at least one processor, the at least one machine-learning model from the initial format that is based on a first machine-learning programming library to a new format that is based on a second machine-learning programming library different from the first machine-learning programming library. The method may further include determining, with at least one processor, the new format based on a programming language used to operate the server cluster.

In some non-limiting embodiments or aspects, the initial performance metric generated on each node of the at least two nodes may include an error rate based on false positives and false negatives of the at least one converted machine-learning model.

In some non-limiting embodiments or aspects, the at least one combined performance metric may include at least one of the following: area under a receiver operating characteristic (AUROC); model sensitivity; model specificity; false positive rate; false negative rate; error rate; F-score; or any combination thereof.

In some non-limiting embodiments or aspects, the at least one model hyperparameter may include at least one of the following: classification threshold; neural network topology; neural network size; learning rate; or any combination thereof.

According to some non-limiting embodiments or aspects, provided is a system for distributed execution of a machine-learning model on a server cluster. The system includes at least one server including at least one processor. The at least one server is programmed or configured to receive a request identifying at least one machine-learning model. The at least one server is also programmed or configured to initiate retrieval of the at least one machine-learning model from a data repository based on the request. The at least one server is further programmed or configured to convert the at least one machine-learning model from an initial format to an executable format compatible with distributed execution on a server cluster, to produce at least one converted machine-learning model. The at least one server is further programmed or configured to transmit the at least one converted machine-learning model to each node of at least two nodes of the server cluster. The at least one server is further programmed or configured to execute the at least one converted machine-learning model on each node of the at least two nodes using data stored on said each node. The at least one server is further programmed or configured to generate an initial performance metric on each node of the at least two nodes based on execution of the at least one converted machine-learning model on each node of the at least two nodes, to produce a plurality of initial performance metrics. The at least one server is further programmed or configured to transmit the plurality of initial performance metrics from each node of the at least two nodes to a processor external to the server cluster. The at least one server is further programmed or configured to combine the plurality of initial performance metrics to produce at least one combined performance metric for the at least one converted machine-learning model. The at least one server is further programmed or configured to modify at least one model hyperparameter of the at least one machine-learning model based on the at least one combined performance metric, to produce at least one modified machine-learning model. The at least one server is further programmed or configured to execute the at least one modified machine-learning model in a computer system to evaluate real-time event data.

In some non-limiting embodiments or aspects, the request may further include at least one data parameter associated with a subset of data stored in the server cluster. Executing the at least one converted machine-learning model on each node of the at least two nodes may further include inputting the subset of data stored on said each node to the at least one converted machine-learning model based on the at least one data parameter.

In some non-limiting embodiments or aspects, converting the at least one machine-learning model to the executable format compatible with distributed execution in the server cluster may include converting the at least one machine-learning model from the initial format that is based on a first machine-learning programming library to a new format that is based on a second machine-learning programming library different from the first machine-learning programming library. The at least one server may be further programmed or configured to determine the new format based on a programming language used to operate the server cluster.

In some non-limiting embodiments or aspects, the initial performance metric generated on each node of the at least two nodes may include an error rate based on false positives and false negatives of the at least one converted machine-learning model.

In some non-limiting embodiments or aspects, the at least one combined performance metric may include at least one of the following: area under a receiver AUROC; model sensitivity; model specificity; false positive rate; false negative rate; error rate; F-score; or any combination thereof.

In some non-limiting embodiments or aspects, the at least one model hyperparameter may include at least one of the following: classification threshold; neural network topology; neural network size; learning rate; or any combination thereof.

According to some non-limiting embodiments or aspects, provided is a computer program product for distributed execution of a machine-learning model on a server cluster. The computer program product includes at least one non-transitory computer-readable medium including program instructions. The program instructions, when executed by at least one processor, cause the at least one processor to receive a request identifying at least one machine-learning model. The program instructions also cause the at least one processor to initiate retrieval of the at least one machine-learning model from a data repository based on the request. The program instructions further cause the at least one processor to convert the at least one machine-learning model from an initial format to an executable format compatible with distributed execution on a server cluster, to produce at least one converted machine-learning model. The program instructions also cause the at least one processor to transmit the at least one converted machine-learning model to each node of at least two nodes of the server cluster. The program instructions also cause the at least one processor to execute the at least one converted machine-learning model on each node of the at least two nodes using data stored on said each node. The program instructions also cause the at least one processor to generate an initial performance metric on each node of the at least two nodes based on execution of the at least one converted machine-learning model on each node of the at least two nodes, to produce a plurality of initial performance metrics. The program instructions also cause the at least one processor to transmit the plurality of initial performance metrics from each node of the at least two nodes to a processor external to the server cluster. The program instructions also cause the at least one processor to combine the plurality of initial performance metrics to produce at least one combined performance metric for the at least one converted machine-learning model. The program instructions also cause the at least one processor to modify at least one model hyperparameter of the at least one machine-learning model based on the at least one combined performance metric, to produce at least one modified machine-learning model. The program instructions also cause the at least one processor to execute the at least one modified machine-learning model in a computer system to evaluate real-time event data.

In some non-limiting embodiments or aspects, the request may further include at least one data parameter associated with a subset of data stored in the server cluster. Executing the at least one converted machine-learning model on each node of the at least two nodes may further include inputting the subset of data stored on said each node to the at least one converted machine-learning model based on the at least one data parameter.

In some non-limiting embodiments or aspects, converting the at least one machine-learning model to the executable format compatible with distributed execution in the server cluster may include converting the at least one machine-learning model from the initial format that is based on a first machine-learning programming library to a new format that is based on a second machine-learning programming library different from the first machine-learning programming library. The program instructions may further cause the at least one processor to determine the new format based on a programming language used to operate the server cluster.

In some non-limiting embodiments or aspects, the initial performance metric generated on each node of the at least two nodes may include an error rate based on false positives and false negatives of the at least one converted machine-learning model.

In some non-limiting embodiments or aspects, the at least one combined performance metric may include at least one of the following: AUROC; model sensitivity; model specificity; false positive rate; false negative rate; error rate; F-score; or any combination thereof.

In some non-limiting embodiments or aspects, the at least one model hyperparameter may include at least one of the following: classification threshold; neural network topology; neural network size; learning rate; or any combination thereof.

Other non-limiting embodiments or aspects will be set forth in the following numbered clauses:

Clause 1: A computer-implemented method comprising: receiving, with at least one processor, a request identifying at least one machine-learning model; initiating retrieval, with at least one processor, of the at least one machine-learning model from a data repository based on the request; converting, with at least one processor, the at least one machine-learning model from an initial format to an executable format compatible with distributed execution on a server cluster, to produce at least one converted machine-learning model; transmitting, with at least one processor, the at least one converted machine-learning model to each node of at least two nodes of the server cluster; executing, with at least one processor, the at least one converted machine-learning model on each node of the at least two nodes using data stored on said each node; generating, with at least one processor, an initial performance metric on each node of the at least two nodes based on execution of the at least one converted machine-learning model on each node of the at least two nodes, to produce a plurality of initial performance metrics; transmitting, with at least one processor, the plurality of initial performance metrics from each node of the at least two nodes to a processor external to the server cluster; combining, with at least one processor, the plurality of initial performance metrics to produce at least one combined performance metric for the at least one converted machine-learning model; modifying, with at least one processor, at least one model hyperparameter of the at least one machine-learning model based on the at least one combined performance metric, to produce at least one modified machine-learning model; and executing, with at least one processor, the at least one modified machine-learning model in a computer system to evaluate real-time event data.

Clause 2: The computer-implemented method of clause 1, wherein the request further comprises at least one data parameter associated with a subset of data stored in the server cluster, and wherein executing the at least one converted machine-learning model on each node of the at least two nodes further comprises inputting the subset of data stored on said each node to the at least one converted machine-learning model based on the at least one data parameter.

Clause 3: The computer-implemented method of clause 1 or clause 2, wherein converting the at least one machine-learning model to the executable format compatible with distributed execution in the server cluster comprises: converting, with at least one processor, the at least one machine-learning model from the initial format that is based on a first machine-learning programming library to a new format that is based on a second machine-learning programming library different from the first machine-learning programming library.

Clause 4: The computer-implemented method of any of clauses 1-3, further comprising determining, with at least one processor, the new format based on a programming language used to operate the server cluster.

Clause 5: The computer-implemented method of any of clauses 1-4, wherein the initial performance metric generated on each node of the at least two nodes comprises an error rate based on false positives and false negatives of the at least one converted machine-learning model.

Clause 6: The computer-implemented method of any of clauses 1-5, wherein the at least one combined performance metric comprises at least one of the following: area under a receiver operating characteristic (AUROC); model sensitivity; model specificity; false positive rate; false negative rate; error rate; F-score; or any combination thereof.

Clause 7: The computer-implemented method of any of clauses 1-6, wherein the at least one model hyperparameter comprises at least one of the following: classification threshold; neural network topology; neural network size; learning rate; or any combination thereof.

Clause 8: A system comprising at least one server comprising at least one processor, wherein the at least one server is programmed or configured to: receive a request identifying at least one machine-learning model; initiate retrieval of the at least one machine-learning model from a data repository based on the request; convert the at least one machine-learning model from an initial format to an executable format compatible with distributed execution on a server cluster, to produce at least one converted machine-learning model; transmit the at least one converted machine-learning model to each node of at least two nodes of the server cluster; execute the at least one converted machine-learning model on each node of the at least two nodes using data stored on said each node; generate an initial performance metric on each node of the at least two nodes based on execution of the at least one converted machine-learning model on each node of the at least two nodes, to produce a plurality of initial performance metrics; transmit the plurality of initial performance metrics from each node of the at least two nodes to a processor external to the server cluster; combine the plurality of initial performance metrics to produce at least one combined performance metric for the at least one converted machine-learning model; modify at least one model hyperparameter of the at least one machine-learning model based on the at least one combined performance metric, to produce at least one modified machine-learning model; and execute the at least one modified machine-learning model in a computer system to evaluate real-time event data.

Clause 9: The system of clause 8, wherein the request further comprises at least one data parameter associated with a subset of data stored in the server cluster, and wherein executing the at least one converted machine-learning model on each node of the at least two nodes further comprises inputting the subset of data stored on said each node to the at least one converted machine-learning model based on the at least one data parameter.

Clause 10: The system of clause 8 or clause 9, wherein converting the at least one machine-learning model to the executable format compatible with distributed execution in the server cluster comprises: converting the at least one machine-learning model from the initial format that is based on a first machine-learning programming library to a new format that is based on a second machine-learning programming library different from the first machine-learning programming library.

Clause 11: The system of any of clauses 8-10, wherein the at least one server is further programmed or configured to determine the new format based on a programming language used to operate the server cluster.

Clause 12: The system of any of clauses 8-11, wherein the initial performance metric generated on each node of the at least two nodes comprises an error rate based on false positives and false negatives of the at least one converted machine-learning model.

Clause 13: The system of any of clauses 8-12, wherein the at least one combined performance metric comprises at least one of the following: area under a receiver operating characteristic (AUROC); model sensitivity; model specificity; false positive rate; false negative rate; error rate; F-score; or any combination thereof.

Clause 14: The system of any of clauses 8-13, wherein the at least one model hyperparameter comprises at least one of the following: classification threshold; neural network topology; neural network size; learning rate; or any combination thereof.

Clause 15: A computer program product comprising at least one non-transitory computer-readable medium comprising program instructions that, when executed by at least one processor, cause the at least one processor to: receive a request identifying at least one machine-learning model; initiate retrieval of the at least one machine-learning model from a data repository based on the request; convert the at least one machine-learning model from an initial format to an executable format compatible with distributed execution on a server cluster, to produce at least one converted machine-learning model; transmit the at least one converted machine-learning model to each node of at least two nodes of the server cluster; execute the at least one converted machine-learning model on each node of the at least two nodes using data stored on said each node; generate an initial performance metric on each node of the at least two nodes based on execution of the at least one converted machine-learning model on each node of the at least two nodes, to produce a plurality of initial performance metrics; transmit the plurality of initial performance metrics from each node of the at least two nodes to a processor external to the server cluster; combine the plurality of initial performance metrics to produce at least one combined performance metric for the at least one converted machine-learning model; modify at least one model hyperparameter of the at least one machine-learning model based on the at least one combined performance metric, to produce at least one modified machine-learning model; and execute the at least one modified machine-learning model in a computer system to evaluate real-time event data.

Clause 16: The computer program product of clause 15, wherein the request further comprises at least one data parameter associated with a subset of data stored in the server cluster, and wherein executing the at least one converted machine-learning model on each node of the at least two nodes further comprises inputting the subset of data stored on said each node to the at least one converted machine-learning model based on the at least one data parameter.

Clause 17: The computer program product of clause 15 or clause 16, wherein converting the at least one machine-learning model to the executable format compatible with distributed execution in the server cluster comprises: converting the at least one machine-learning model from the initial format that is based on a first machine-learning programming library to a new format that is based on a second machine-learning programming library different from the first machine-learning programming library.

Clause 18: The computer program product of any of clauses 15-17, wherein the program instructions further cause the at least one processor to determine the new format based on a programming language used to operate the server cluster.

Clause 19: The computer program product of any of clauses 15-18, wherein the initial performance metric generated on each node of the at least two nodes comprises an error rate based on false positives and false negatives of the at least one converted machine-learning model.

Clause 20: The computer program product of any of clauses 15-19, wherein the at least one combined performance metric comprises at least one of the following: area under a receiver operating characteristic (AUROC); model sensitivity; model specificity; false positive rate; false negative rate; error rate; F-score; or any combination thereof.

Clause 21: The computer program product of any of clauses 15-20, wherein the at least one model hyperparameter comprises at least one of the following: classification threshold; neural network topology; neural network size; learning rate; or any combination thereof.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the disclosure are explained in greater detail below with reference to the exemplary embodiments that are illustrated in the accompanying figures, in which:

FIG. 1 is a schematic diagram of an overall environment for distributed execution of machine-learning models, according to some non-limiting embodiments or aspects;

FIG. 2 is a schematic diagram of a system for distributed execution of machine-learning models, according to some non-limiting embodiments or aspects;

FIG. 3 is a diagram of one or more components, devices, and/or systems, according to some non-limiting embodiments or aspects;

FIG. 4 is a flow diagram of a method for distributed execution of machine-learning models, according to some non-limiting embodiments or aspects; and

FIG. 5 is a flow diagram of a method for distributed execution of machine-learning models, according to some non-limiting embodiments or aspects.

It should be appreciated by those skilled in the art that any block diagrams herein represent conceptual views of illustrative systems embodying the principles of the present subject matter. Similarly, it may be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

For purposes of the description hereinafter, the terms “upper”, “lower”, “right”, “left”, “vertical”, “horizontal”, “top”, “bottom”, “lateral”, “longitudinal,” and derivatives thereof shall relate to non-limiting embodiments or aspects as they are oriented in the drawing figures. However, it is to be understood that non-limiting embodiments or aspects may assume various alternative variations and step sequences, except where expressly specified to the contrary. It is also to be understood that the specific devices and processes illustrated in the attached drawings, and described in the following specification, are simply exemplary embodiments or aspects. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “communication” may refer to the reception, receipt, transmission, transfer, provision, and/or the like, of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer. An “application” or “application program interface” (API) may refer to computer code or other data sorted on a computer-readable medium that may be executed by a processor to facilitate the interaction between software components, such as a client-side front-end and/or server-side back-end for receiving data from the client. An “interface” may refer to a generated display, such as one or more graphical user interfaces (GUIs) with which a user may interact, either directly or indirectly (e.g., through a keyboard, mouse, etc.).

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, computers, servers, input devices, and/or other like devices that can be used to initiate a payment transaction.

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

The systems, methods, and computer program products described herein provide numerous technical advantages and improvements in systems for executing a machine-learning model on multiple server nodes. As described herein, the disclosure provides for vast reduction in computer resource requirements for bringing a machine-learning model from development, through training and testing, and to execution in a production environment. The reduction in computer resource requirements include, but are not limited to, reduced bandwidth, reduced data retrieval time, reduced machine-learning model execution time, reduced changes in storage requirements at a processor executing the machine learning model, and/or the like. These benefits are provided by moving the machine-learning model to the stored data (e.g., retrieving from a repository and transmitting to nodes for execution) rather than by moving the stored data to the machine-learning model. The benefits are further provided by executing the machine-learning model across a plurality of nodes of a server cluster that stores the data for use as input to the machine-learning model, which reduces runtime and allows for segmented calculation of performance metrics.

The present disclosure also addresses the technical problem of machine-learning models being developed in multiple different formats (e.g., types of exported files generated from specific programming library), which may be incompatible with the format that data is stored on a server cluster. In particular, the present disclosure converts machine-learning models from an initial format (e.g., a format as exported or stored in a data repository) and to an executable format that is compatible with distributed execution on a server cluster. The present disclosure improves the overall efficiency of a process flow that involves machine-learning model format conversion, by converting each machine-learning model in the steps between and/or including retrieval and loading of the machine-learning model in each node of the server cluster. In this manner, the machine-learning models may be developed and stored in a format most conducive to model developers, and the machine-learning models may still be imported and loaded for execution in a format that is executable in the distributed environment.

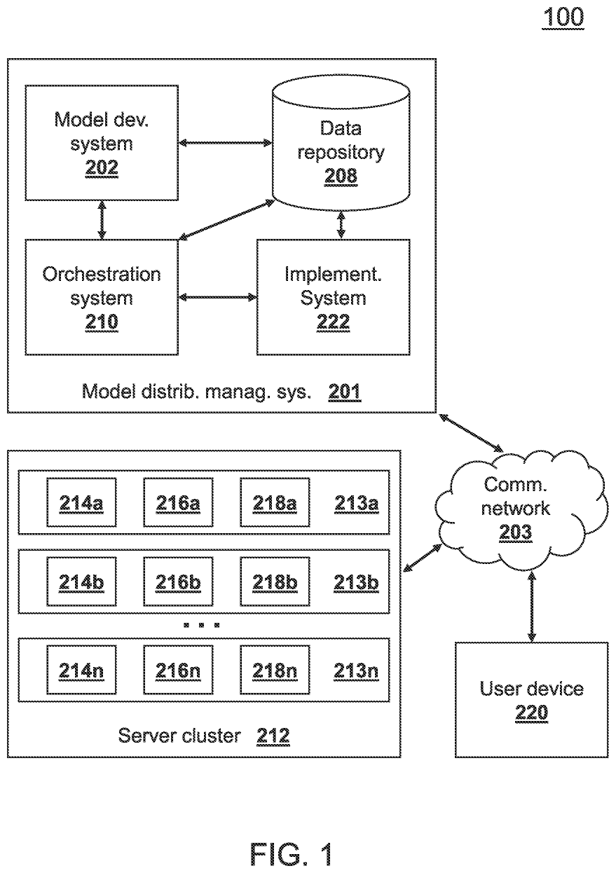

Referring now to FIG. 1, an overall environment 100 for distributed execution of machine-learning models is shown, according to some non-limiting embodiments or aspects. Specifically, the overall environment 100 may include a model distribution management system 201, a server cluster 212, and a user device 220 that communicate at least partially over one or more communication networks 203.

The model distribution management system 201 may include one or more computing devices for generating, training, executing, evaluating, and/or implementing machine-learning models. The model distribution management system 201 may include a model development system 202, a data repository 208, an orchestration system 210, and/or an implementation system 222. One or more of the systems depicted in model distribution management system 201 may be included in a same system. The model distribution management system 201 may be configured to communicate with a user device 220 and/or a server cluster 212, at least partially over one or more communication networks 203. The model distribution management system 201 may include, be associated with, or be included in a transaction processing system. Communications described or depicted between the model distribution management system 201 and a server cluster 212 and/or a user device 220 may be transmitted to or from one or more systems included in the model distribution management system 201.

The model development system 202 may include one or more computing devices for initializing (e.g., writing the code for) and/or initially training machine-learning models. The model development system 202 may be configured to communicate with the data repository 208 and/or the orchestration system 210, at least partially over one or more communication networks 203. Users (e.g., data scientists) may use the model development system 202 to produce a plurality of machine-learning models to be tested. One or more machine-learning models generated in the model development system 202 may be exported in an initial format and stored in the data repository 208.

The data repository 208 may include one or more computing devices for storing machine-learning models in an initial format. The data repository 208 may be configured to communicate with the model development system 202, the orchestration system 210, and/or the implementation system 222. The data repository 208 may include one or more databases, data stores, and/or the like for storing data (e.g., of machine-learning models) in a searchable arrangement. Machine-learning models stored in the data repository 208 may be retrieved based on one or more identifiers associated with the machine-learning model. A user that desires to evaluate a machine-learning model stored in the data repository 208 may identify the machine-learning model using said one or more identifiers in a request transmitted from the user device 220. Machine-learning models may be routinely retrieved by the orchestration system 210 from the data repository 208, modified, and re-stored in the data repository 208.

The orchestration system 210 may include one or more computing devices for retrieving, transmitting, executing, evaluating, and/or modifying machine-learning models in the depicted overall environment 100. The orchestration system 210 may be configured to communicate with the model development system 202, the data repository 208, the server cluster 212 (including one or more server nodes 213a-213n thereof), the user device 220, and/or the implementation system 222. The orchestration system 210 may execute a routine (e.g., a process, such as a software algorithm) that binds other routines (e.g., model store routine, model conversion routine, model execution routine, model evaluation routine, and/or the like) to create a workflow that gets executed after a user configures all the required components and triggers the orchestration system 210. The orchestration system 210 may receive one or more requests to evaluate one or more machine-learning models from the user device 220. The orchestration system 210 may collect model evaluation results from the server cluster 212, generate model reports (e.g., performance metric results), and deliver said model reports to the user device 220.

The orchestration system 210 may execute an orchestration routine for each user request to evaluate a machine-learning model. The orchestration routine may include a number of additional steps to receive machine-learning models from a data repository 208 and facilitate distributed execution on a server cluster 212. First, the orchestration system 210 may infer the model type (e.g., format) of the requested machine-learning model, based on one or more parameters of the stored machine-learning model. The orchestration system 210 may fetch model binaries from a model store (e.g., the data repository 208), then execute a conversion routine using the model type as an input. Then, the orchestration system 210 may read user configurations in the request based on user-defined data elements. Also based on the user request, the orchestration system 210 may identify the data partitions (e.g., nodes) of the server cluster 212 that contain the data that will be used as inputs for evaluating, training, testing, etc., the machine-learning model.

The orchestration system 210 may cause an execution routine to be executed on one or more nodes of the server cluster 212 based on each user request to evaluate a machine-learning model. The execution routine may be a function that accepts data row (e.g., a record as stored on a server node) and model as inputs. If the machine-learning model is not initialized, the orchestration system 210 may execute a container initializing function, load model binaries, and trigger the model binaries. The orchestration system 210 may then run different model execution routines based on the original model type (e.g., format). For example, if the original model is a Tensorflow®-exported model, the orchestration system 210 may convert the data row input to a tensor, which is a multi-dimensional array with a uniform type. The orchestration system 210 may then cause the server node to run a model execution function using the tensor as the input. By way of further example, if the original model type is an H2O™-exported model, the orchestration system 210 may convert the data row input to an H2O™ RowData class and cause the server node to run a model execution function using the RowData class object as input. By way of further example, if the original model type is a Scikit-Learn®-exported model or a Spark™ ML-exported model, the orchestration system 210 may convert the data row input to a PMML field map and cause the server node to execute a model execution function using the map object as an input.

The orchestration system 210 may cause an evaluation routine to be executed on one or more nodes of the server cluster 212 after the execution routine. For example, in the evaluation routine, the server node may fetch the results from the execution routine and load the results to a Spark™ DataFrame, read any received user configurations, read model configurations, fetch additional datasets (if required for generating a performance report) and load them to the Spark™ Data Frame, and execute an evaluation function. The evaluation function may include one or more initial (e.g., partial) metric functions, including, but not limited to, a score distribution metric function, an accuracy metric function, a sensitivity metric function, a specificity metric function, an F-score metric function, an AUROC metric function, and/or the like. The computing device may then build the model schema, which may include a model identifier, model configurations, hyperparameters, and an initial performance metrics object. The computing device may further convert the execution results from evaluation logic to the schema format and push the data to storage (e.g., in the server node).

The orchestration system 210 may execute a feature impact analysis routine after the execution and evaluation routines. The feature impact analysis routine may be executed by the orchestration system 210. Permutation importance logic may be used for the feature impact analysis routine. In this routine, for each machine-learning model and each feature of the machine-learning model (e.g., an independent variable acting as input to the machine-learning model), the selection of input data may be shuffled and input again using the above-described execution and evaluation routines. Using the old and new outputs of the machine-learning model, the impact of the change in input may be calculated using a loss function, and the weight of each model feature may be determined. After calculating the weight of each model feature for each model, the results may be aggregated to find the overall impact of each model feature. The results may be output (e.g., to the user device 220, to the model development system 202, etc.) for use by a user (e.g., a data scientist) for subsequent training processes and/or to identify the best model features.

The orchestration system 210 may execute a hyperparameter tuning routine after the execution and evaluation routines. When training a number of models, the large amount of data may make identifying the best initial hyperparameters time- or resource-prohibitive. Therefore, random hyperparameters may be used to initially create the models (e.g., in the model development system 202), and the hyperparameter tuning routine may then help identify the best hyperparameters. For example, for each model and for each hyperparameter value, the orchestration system 210 may assign a score to the hyperparameter value. The score may be calculated using the combined performance metrics and the combination of hyperparameter values. To calculate the hyperparameter score associated with each pre-trained value, the orchestration system 210 may use a Gaussian process as the surrogate to learn the mapping from the hyperparameter configuration to the performance metrics. The orchestration system 210 may follow the first steps of a Gaussian process optimization on a single hyperparameter variable, such as learning rate, batch size, number of layers, dropout rate, and/or the like. The Gaussian process may be a Sequential Model Based Optimization (SMBO) class of algorithm. After hyperparameter value scores and ranks are determined, the value ranks may be stored and/or provided to a user (e.g., via the user device 220, the model development system 202, etc.).

The orchestration system 210 may execute an ensemble analysis routine after the execution and evaluation routines for a plurality of machine-learning models. For example, a user may train a number of machine-learning models and want to figure out which machine-learning model to use in a production environment (e.g., implementation system 222). Individual model performance may be determined using the above-described evaluation routine for each machine-learning model. The ensemble analysis routine may allow for the combination of different models, and for a score to be generated for combinations of different models to come up with the best model output (e.g., prediction). For example, a Bayesian method may be used to find the best combination of machine-learning models. Bayesian methods work by finding the next set of weights to evaluate on the actual objective function by selecting weights that perform best on the surrogate function. Such a Bayesian method may determine the best ensemble combination of machine-learning models that could work better than an individual machine-learning model. The ensemble analysis routine may include retrieving all model performance metrics for a same input dataset, getting a range of weights for model inputs (e.g., defined by a user), and generating a grid with all possible combinations for models and weights. The ensemble analysis routine may further include, for each combination of model and weight: determining an average score for the grid rows; running performance analytics; and saving performance analytics. The performance results of the ensemble analysis may be provided to a user (e.g., via the user device 220, the model development system 202, etc.).

The implementation system 222 may include one or more computing devices for executing at least one machine-learning model to evaluate real-time event data. The implementation system 222 may be associated with a production environment (e.g., in contrast to a test environment) to carry out services, e.g., for or associated with a transaction service provider. For example, the implementation system 222 may be a fraud detection system, and the executed machine-learning model may be used to detect fraud in real-time transaction data. By way of further example, the implementation system 222 may be a credit extension system, and the executed machine-learning model may be used to determine whether credit should be extended for credit-type transactions based on real-time transaction data. In another example, the implementation system 222 may be a computer-driven advertisement system, and the executed machine-learning model may be used to trigger relevant advertisements to payment device users based on real-time transaction data (e.g., transaction data received and processed in real-time, for example, in a live situation, such as a time at which or close to a time at which operations, such as operations of a transaction processing system or other system or device, are carried out). It will be appreciated that many arrangements and configurations are possible. The implementation system 222 may be configured to communicate with the data repository 208 to receive machine-learning models from the data repository 208 for execution in the production environment. The implementation system 222 may be configured to communicate with orchestration system 210 to receive modified machine-learning models for execution in the production environment. The implementation system 222 may be further configured to communicate with the user device 220 to configure machine-learning models for execution on real-time event data.

The server cluster 212 may include a plurality of server nodes 213a-213n, on which a machine-learning model may be distributed for execution. The server cluster 212 may store event data (e.g., transaction data). The server cluster 212 may be configured to communicate with the orchestration system 210 so that a converted machine-learning model may be loaded, executed, and evaluated on each node of the plurality of nodes 213a-213n. Each of the plurality of nodes 213a-213n may store a subset of the data that may be used to train and/or evaluate a machine-learning model. For example, a first node 213a of the server cluster 212 may store a first subset of data, and a machine-learning model may be retrieved by the orchestration system 210, converted by the orchestration system 210, and imported to the first node 213a in a first load routine 214a. The first node 213a may then execute a first execution routine 216a to input the subset of data from the first node 213a to the machine-learning model. The first node 213a may then execute a first evaluation routine 218a to determine an initial performance metric of the machine-learning model as executed on the first subset of data stored on the first node 213a. The plurality of nodes 213a-213n may have respective load routines 214-214n, execution routines 216a-216n, and evaluation routines 218a-218n. When evaluating a machine-learning model, the orchestration system 210 may cause the machine-learning model to be converted, loaded, executed, and evaluated across one or more of the plurality of server nodes 213a-213n, which may be all or less than the total number of server nodes 213a-213n.

If required by the type of machine-learning model, the orchestration system 210 may communicate with the server cluster 212 to repartition the data stored thereon, to optimize execution of the machine-learning model. For example, if the machine-learning model is a convolutional neural network (CNN), perceptron model, or autoencoder model, the orchestration system 210 may read the model configurations, infer the data schema, execute a function to determine differences in the schema, and if a difference in the schema is detected, the orchestration system 210 may repartition the data on the server cluster 212. If a difference in the schema is not detected, the orchestration system 210 may not repartition the data. By way of further example, if the machine-learning model is a recurrent neural network (RNN), the orchestration system 210 may read the model configurations, infer the data schema, execute a sequence generator function, and repartition the data.

If repartitioning is required, the orchestration system 210 may trigger a repartition function, fetch feature engineering configurations, build the feature engineering logic, build the execution package for the repartitioning, and distribute the execution package to the existing partitions (e.g., nodes) for repartitioning of the data thereon.

When the orchestration system 210 has determined the partitions on which to execute the machine-learning model, for each partition thereof, the orchestration system 210 may carry out user-defined data conversions that are required in the user request. Such conversion routines may include getting the original model type and the desired model type, checking the compatibility of the original and desired model types, and converting the original model type to the desired model type, where applicable. After the conversion routine, the orchestration system 210 may execute a feature engineering function, execute the model execution routine, and execute the model evaluation routine for each partition.

The user device 220 may include one or more computing devices configured to communicate with the orchestration system 210, at least partially over one or more communication networks 203. The user device 220 may include a user interface (e.g., one or more applications, web pages, and/or the like) to allow a user to interact in the overall environment 100. The user device 220 may transmit (e.g., to the orchestration system 210) one or more requests for evaluating machine-learning models, and such requests may include one or more identifiers to identify the one or more machine-learning models to be evaluated. A request may include, or be included in, a message, data packet, data signal, and/or the like, transmitted from the user device 220 to the orchestration system 210. The user device 220 may include a display for showing reports of evaluated machine-learning models. The user device 220 may further be configured with a display to receive input from a user to modify one or more parameters of machine-learning models that are evaluated, receive input to further specify the scope of evaluating machine-learning models, and to display results (e.g., reports) of evaluated machine-learning models. The user device 220 may be further configured to communicate with the implementation system 222, at least partially over one or more communication networks 203, to set up and execute trained machine-learning models in a production environment.

The depicted environment 100 may be executed with the foregoing components communicating across one or more communication networks 203. The one or more communication networks 203 may include one or more wired and/or wireless networks. For example, a communication network 203 may include a cellular network (e.g., a long-term evolution (LTE®) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network, an ad hoc network, a mesh network, a beacon network, an intranet, the Internet, a fiber optic-based network, a cloud computing network, and/or the like, and/or a combination of these or other types of networks.

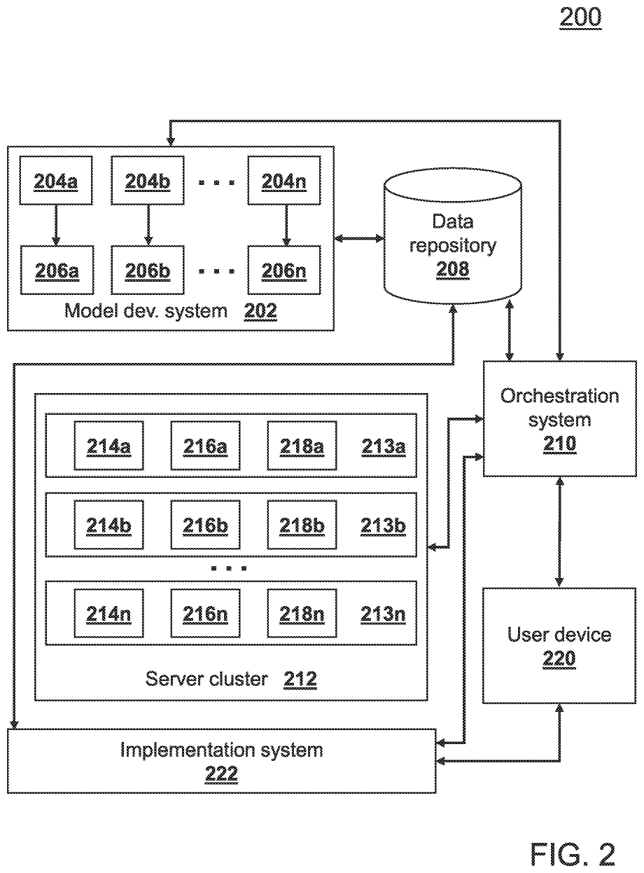

Referring now to FIG. 2, a system 200 for distributed execution of machine-learning models is shown, according to some non-limiting embodiments or aspects. Specifically, the system 200 may include a model development system 202, a data repository 208, an orchestration system 210, a server cluster 212 having a plurality of server nodes 213a-213n, a user device 220, and an implementation system 222.

The model development system 202 may further include a plurality of machine-learning development frameworks 204a-204n (also referred to herein as machine-learning programming libraries, such as Tensorflow®, H2O™, Scikit-Learn®, Keras™, Spark™ ML, etc.) for producing machine-learning models. The plurality of machine-learning development frameworks 204a-204n may be configured to generate a corresponding plurality of formats 206a-206n (e.g., model types) of exported machine-learning models (e.g., Tensorflow® generates a SavedModel format, Scitkit-Learn® generates a Pickle format, etc.). One or more machine-learning models generated in the model development system 202 may be exported in an initial format 206a-206n and stored in the data repository 208.

The orchestration system 210 provides the technical benefit of being agnostic to model format, given that the processes executed by the orchestration system 210 allow for testing that is independent of model type or deep learning architecture type. For example, the orchestration system 210 may execute a conversion routine that converts a machine-learning model from an initial format as stored in the data repository 208 to a second format that is compatible with execution in a distributed environment (e.g., in the server cluster 212). By way of further example, if the server cluster 212 is configured to operate in Java Virtual Machine (JVM®), the model may be converted to a format that can be executed in JVM®. Custom conversion functions may be written on top of Apache® Spark™ to convert from the format of one or more of a plurality of machine-learning development frameworks 204a-204n. The orchestration system 210 may also build dynamic containers that execute the other processes (e.g., routines) described herein.

The conversion routine may be a function of the orchestration system 210 that accepts model type (e.g., format) as an input. Based on the model type, the conversion routine may execute different steps to convert from the original model type to the target model type. For example, if the original model type is a Tensorflow®-exported model, the orchestration system 210 may load Tensorflow® serving binaries, convert the binaries to Java® executables, build the executable container, and dynamically embed the Tensorflow®-exported model into the container for execution on a server node. By way of further example, if the original model type is an H2O™-exported model, the orchestration system 210 may fetch H2O™ inference binaries, convert the binaries to Java® executables, build the executable container, and dynamically embed the H2O™-exported model into the container for execution on a server node. By way of further example, if the original model type is a Scikit-Learn®-exported model, the orchestration system 210 may load the Predictive Model Markup Language (PMML) binaries, convert the binaries to Java® executables, build the executable container, and dynamically embed the Scikit-Learn®-exported model into the container for execution on a server node. By way of further example, if the original model type is a Spark™ ML-exported model, the orchestration system 210 may fetch the Java®-class PMML binaries, convert the binaries to Java® executables, build the executable container, and dynamically embed the Spark™ ML-exported model into the container for execution on a server node.

A method for distributed execution of a machine-learning model in a server cluster 212 may be executed in the depicted system 200. The orchestration system 210 may receive, from the user device 220, a request identifying at least one machine-learning model. The request may further identify the data (e.g., based on a category or parameter of the data, such as retail transaction data, grocery transaction data, etc.) in the server cluster 212 to input to the machine-learning model for evaluating the machine-learning model. In response to receiving the request, the orchestration system 210 may retrieve, or initiate retrieval of, the at least one machine-learning model from the data repository 208 based on the request. Before, during, or after retrieval of the at least one machine-learning model from the data repository 208, the orchestration system 210 may convert the at least one machine-learning model from an initial format (e.g., as stored in the data repository 208) to an executable format compatible with distributed execution on the server cluster 212. The orchestration system 210 may thereby produce at least one converted machine-learning model.

After converting the at least one machine-learning model, the orchestration system 210 may determine one or more nodes of the plurality of server nodes 213a-213n of the server cluster 212 that contain data to use as input and to evaluate the machine-learning model. If the user specified the data to be used for evaluating the model (e.g., in the request), the orchestration system 210 may reference said specification and identify where, among the partitioned data stored in the server cluster 212, the data is being stored and identify the corresponding nodes (e.g., on which the data is stored) to receive the machine-learning model. Based on the nodes identified by the orchestration system 210 to receive the model, the orchestration system 210 may transmit the at least one converted machine-learning model to one or more nodes of the plurality of server nodes 213a-213n.

After one or more nodes of the server cluster 212 receive the converted machine-learning model, the orchestration system 210 may execute, or cause to be executed, the at least one converted machine-learning model on each node that received the converted machine-learning model using data stored on the respective node. For example, if a first node 213a was determined to have data to use as an input for evaluating the machine-learning model, the first node 213a may receive the converted machine-learning model and execute the converted machine-learning model on the first node 213a using, as input, data stored on the first node 213a. The data used as input to the converted machine-learning model on a given node may be all or a subset of the data stored on the given node. Based on execution of the converted machine-learning model, the orchestration system 210 may generate, or cause to be generated, an initial performance metric on each node that received and executed the converted machine-learning model. The initial performance metric may be based on the execution of the converted machine-learning model on the respective node of the server cluster 212.

For example, individual initial performance metrics may be generated on each node that executed the converted machine-learning model. A metric may be generated in the same container within which the model is evaluated. An initial performance metric on a given node may also be referred to herein as a partial performance metric, since initial performance metrics may be combined across nodes to generate a combined performance metric that reflects an evaluation of the machine-learning model as executed across all relevant nodes. Because the data being used to evaluate a model and generate an initial performance metric is only a fraction of all of the data stored in the server cluster 212, network traffic may be reduced significantly.

By way of further example, an evaluated machine-learning model may produce an output of the binary classifier type. Binary classifiers may predict all data instances of a test dataset as either positive or negative. The classification (e.g., prediction) may produce four outcomes: true positive (e.g., correct positive prediction), true negative (e.g., correct negative prediction), false positive (e.g., incorrect positive prediction), and false negative (e.g., incorrect negative prediction). An evaluation routine on a server node may execute the following process to generate an initial performance metric: (i) stream the labels from the source data sets to the evaluation container (e.g., the node); (ii) calculate the number of true positives (TP), the number of true negatives (TN), the number of false positives (FP), and the number of false negatives (FN) for the data available within the container (e.g., the node); and (iii) calculate an initial performance metric based on TP, TN, FP, and FN. To illustrate, error rate may be used as an initial performance metric, which may be calculated according to the following formula:

$$ERR = \frac{FP + FN}{TP + TN + FN + FP} = \frac{FP + FN}{P + N} \qquad Formula 1$$

The foregoing evaluation routine may be executed on each node that received and executed the converted machine-learning model. Each node may transmit the results of such evaluations to the orchestration system 210. For example, a data object having the following data structure may be created at each node to convey the results of the evaluation: {Data Partition Identifier, Category, Calculated_metrics, List<Supporting Data points>}, where “Data Partition Identifier” represents the node, “Category” represents the subset of data on the node used as input for the machine-learning model, “Calculated_metrics” represents one or more initial performance metrics, and “List<Supporting Data points>” represents one or more portions of data included to substantiate the generated initial performance metric, which may include FP, FN, TP, or TN. A data object having the foregoing data structure may be transmitted from each node used to evaluate the machine-learning model to the orchestration system 210.

After the plurality of initial performance metrics are received by the orchestration system 210, the orchestration system 210 may combine the plurality of initial performance metrics to produce at least one combined performance metric for the converted machine-learning model, which may represent the performance of the machine-learning model across all data that was input to the machine-learning model across all nodes. The orchestration system 210 may wait until all the evaluation routines are completed to produce a combined performance metric. The combined performance metric may use the same formulas as the initial performance metrics, but for the entire data set (e.g., calculating error rate for the entire data set by summing the TP, TN, FP, and FN for all initial performance metrics and using Formula 1). The plurality of initial performance metrics and/or the combined performance metrics may be transmitted from the orchestration system 210 to the user device 220 for display to the user, to provide evaluation feedback. A combined performance metric may include, but is not limited to: AUROC; model sensitivity (e.g., model recall, which is true positive rate, being the number of true positives divided by the sum of true positives and false negatives); model specificity (e.g., true negative rate, being the number of true negatives divided by the sum of true negatives and false positives); false positive rate (e.g., number of false positives divided by the sum of true negatives and false positives); false negative rate (e.g., number of false negatives divided by the sum of true positives and false negatives); error rate; F-score (e.g., F₁ score, F_{β} score, etc.); model precision (e.g., number of true positives divided by the sum of true positives and false negatives); or any combination thereof. The F-score may be calculated according to the following formula:

$${F}_{β} = \frac{( 1 + {β}^{2} ) ( PREC \cdot REC )}{( {β}^{2} \cdot PREC \cdot REC )} , \qquad Formula 2$$

where “PREC” stands for model precision (e.g., number of true positives divided by the sum of true positives and false negatives), “REC” stands for model recall (e.g., the number of true positives divided by the sum of true positives and false negatives), and β is a positive real factor (e.g., a weight) chosen such that recall is considered β times as important as precision. If multiple combined performance metrics are produced, the multiple performance metrics may be presented to the user.

Based on the at least one combined performance metric, the orchestration system 210 may modify at least one model hyperparameter of the at least one machine-learning model, to produce a modified machine-learning model. Hyperparameters may include, but are not limited to: classification threshold (e.g., a decision threshold that is used to convert a quantitative model output to a classifier output); neural network topology (e.g., add, remove, or modify one or more connections of nodes of the neural network); neural network size (e.g., add, remove, or modify nodes of the neural network); learning rate (e.g., how much to change the model in response to estimated error each time the model weights are updated); or any combination thereof. For example, a higher error rate may lead to more modifications to the neural network topology or neural network size, a more significant change in the threshold, and/or a more significant shift in the learning rate, to address the higher error rate.

After the machine-learning model is modified, the modified machine-learning model may be re-stored in the data repository 208 and/or re-distributed to the server cluster 212 for additional training and testing. It will be appreciated that the machine-learning model may be placed into a testing and training loop (e.g., repeated cycle), such that the machine-learning model is repeatedly transmitted to one or more nodes of the server cluster 212, executed on the one or more nodes of the server cluster 212, evaluated on the one or more nodes of the server cluster 212, evaluated at the orchestration system 210 using one or more combined performance metrics, and modified based on the one or more combined performance metrics. For example, at the start of each loop, after the machine-learning model is modified, orchestration system 210 may transmit the machine-learning model to a same or different subset of nodes of the plurality of nodes 213a-213n of the server cluster 212. The orchestration system 210 may then cause the subset of nodes to execute the modified machine-learning model using data stored on the subset of nodes as input to the modified machine-learning model. The subset of nodes may then evaluate the modified machine-learning model by generating, for each node of the subset of nodes, an initial performance metric based on the execution of the modified machine-learning model on said node. The orchestration system 210 may receive, from the subset of nodes, the plurality of initial performance metrics and may determine a combined performance metric from the plurality of initial performance metrics. Based on the combined performance metric, the modified machine-learning model may be further modified, and the orchestration system 210 may start the loop again.

A testing and training loop may provide the added benefit of iterative improvement to optimize the machine-learning model's performance. After one or more cycles of the above-described methods, the model may be determined to be sufficiently accurate (e.g., sufficiently low error rate). After modification, the machine-learning model may be executed in an implementation system 222 (e.g., a production environment) to evaluate real-time event data.

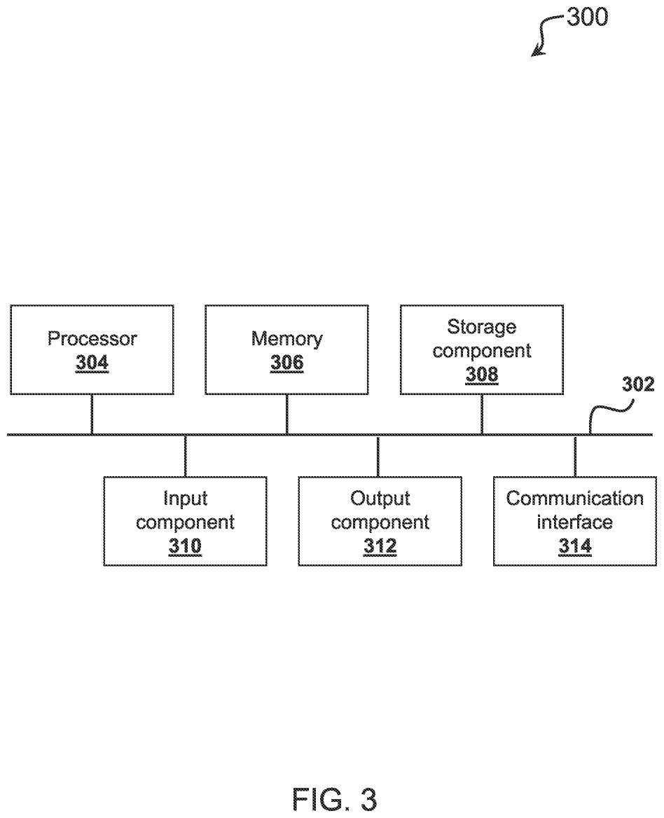

Referring now to FIG. 3, shown is a diagram of example components of a device 300, according to some non-limiting embodiments or aspects. Device 300 may correspond to one or more devices of the model distribution management system 201, the model development system 202, the data repository 208, the orchestration system 210, the server cluster 212, the user device 220, the implementation system 222, and/or one or more communication networks 203 in which the environment 100 and/or system 200 operates, as shown in FIGS. 1 and 2. In some non-limiting embodiments or aspects, such systems or devices may include at least one device 300 and/or at least one component of device 300. The number and arrangement of components shown in FIG. 3 are provided as an example. In some non-limiting embodiments or aspects, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

As shown in FIG. 3, device 300 may include a bus 302, a processor 304, memory 306, a storage component 308, an input component 310, an output component 312, and a communication interface 314. Bus 302 may include a component that permits communication among the components of device 300. In some non-limiting embodiments or aspects, processor 304 may be implemented in hardware, firmware, or a combination of hardware and software. For example, processor 304 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 306 may include random access memory (RAM), read only memory (ROM), and/or another type of dynamic or static storage device (e.g., flash memory, magnetic memory, optical memory, etc.) that stores information and/or instructions for use by processor 304.

With continued reference to FIG. 3, storage component 308 may store information and/or software related to the operation and use of device 300. For example, storage component 308 may include a hard disk (e.g., a magnetic disk, an optical disk, a magneto-optic disk, a solid state disk, etc.) and/or another type of computer-readable medium. Input component 310 may include a component that permits device 300 to receive information, such as via user input (e.g., a touch screen display, a keyboard, a keypad, a mouse, a button, a switch, a microphone, etc.). Additionally, or alternatively, input component 310 may include a sensor for sensing information (e.g., a global positioning system (GPS) component, an accelerometer, a gyroscope, an actuator, etc.). Output component 312 may include a component that provides output information from device 300 (e.g., a display, a speaker, one or more light-emitting diodes (LEDs), etc.). Communication interface 314 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 314 may permit device 300 to receive information from another device and/or provide information to another device. For example, communication interface 314 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 300 may perform one or more processes described herein. Device 300 may perform these processes based on processor 304 executing software instructions stored by a computer-readable medium, such as memory 306 and/or storage component 308. A computer-readable medium may include any non-transitory memory device. A memory device includes memory space located inside of a single physical storage device or memory space spread across multiple physical storage devices. Software instructions may be read into memory 306 and/or storage component 308 from another computer-readable medium or from another device via communication interface 314. When executed, software instructions stored in memory 306 and/or storage component 308 may cause processor 304 to perform one or more processes described herein. Additionally, or alternatively, hardwired circuitry may be used in place of or in combination with software instructions to perform one or more processes described herein. Thus, embodiments or aspects described herein are not limited to any specific combination of hardware circuitry and software. The term “programmed to” or “configured to,” as used herein, may refer to an arrangement of software, device(s), and/or hardware for performing and/or enabling one or more functions (e.g., actions, processes, steps of a process, and/or the like). For example, “a processor programmed or configured to” may refer to a processor that executes software instructions (e.g., program code) that cause the processor to perform one or more functions.

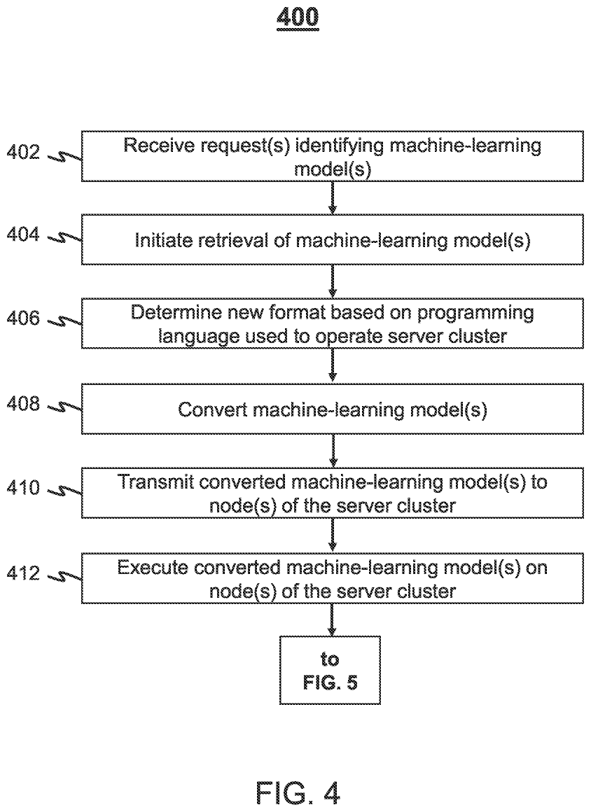

Referring now to FIG. 4, a flow diagram of a method 400 for distributed execution of a machine-learning model on a server cluster is shown, according to some non-limiting embodiments or aspects of the present disclosure. The method 400 may be performed by the model distribution management system 201, the model development system 202, the data repository 208, the orchestration system 210, the server cluster 212 (including one or more nodes 213a-213n thereof), the user device 220, and/or another computing device. One or more steps performed by a first processor may be performed by a same or different processor. The steps shown in FIG. 4 are for example purposes only. It will be appreciated that additional, fewer, different, and/or a different order of steps may be used in non-limiting embodiments or aspects.

In step 402, a request identifying at least one machine-learning model may be received. For example, the orchestration system 210 may receive a request identifying at least one machine-learning model from the user device 220. The request may include a message including one or more model identifiers and/or at least one data parameter associated with a subset of data stored in the server cluster 212. The one or more model identifiers in the user request may be used to identify one or more machine-learning models stored in the data repository 208 so that the one or more machine-learning models may be retrieved for execution, evaluation, modification, and/or the like. The at least one data parameter associated with the subset of data stored in the server cluster 212 may be used to identify which nodes of the server cluster 212 on which to execute the one or more machine-learning models. The user request may also be a plurality of user requests.

In step 404, retrieval of the machine-learning model may be initiated. For example, in response to receiving the user request from the user device 220, the orchestration system 210 may initiate retrieval of the at least one machine-learning model from the data repository 208 based on the user request. By way of further example, the orchestration system 210 may retrieve one or more machine-learning models from the data repository 208 based on one or more model identifiers that correspond to the one or more machine-learning models, which were included in the user request. The one or more machine-learning models stored in the data repository 208 may be stored in an initial format before they are retrieved by the orchestration system 210.

In step 406, a new format may be determined based on a programming language used to operate the server cluster 212. For example, the orchestration system 210 may determine a programming language that is being used to operate the server cluster 212 (e.g., Scala™, Python™, etc.). The orchestration system 210 may then determine a new format, based on the programming language used to operate the server cluster 212, into which to convert the machine-learning model. The new format may include data objects and libraries that are compatible to be input and used in the programming language of the server cluster 212.

In step 408, the machine-learning model may be converted from the initial format into a new format. For example, orchestration system 210 may convert the at least one machine-learning model from an initial format to an executable format compatible with distributed execution on a server cluster 212, to produce at least one converted machine-learning model. In some non-limiting embodiments or aspects, the new format may be determined by the orchestration system 210 in step 406, the user request may specify the new format, the server cluster 212 may identify the new format in a communication to the orchestration system 210, and/or the like. The initial format may be based on (e.g., compatible with, compiled using, etc.) a first machine-learning programming library (e.g., Tensorflow®, H2O™, Scikit-Learn®, Keras™, Spark™ ML, etc.), and the executable format may be a new format that is based on a second machine-learning programming library different from the first machine-learning program library. The new format that is based on (e.g., compatible with, compiled using, etc.) a second machine-learning programming library may be based on a programming language used to operate the server cluster.

In step 410, the converted machine-learning model may be transmitted to one or more nodes of the server cluster 212. For example, after conversion of the machine-learning model, the orchestration system 210 may transmit the at least one converted machine-learning model to each node of at least two nodes (e.g., a first node 213a, a second node 213b, or more) of the server cluster 212. The orchestration system 210 may build a container to execute the converted machine-learning model on each node that receives the converted machine-learning model. The orchestration system 210 may then cause each node that receives the converted machine-learning model to execute the machine-learning model on the subset of data stored on said node.

In step 412, the converted machine-learning model may be executed on the one or more nodes of the server cluster 212 that received the converted machine-learning model. For example, each node that received the converted machine-learning model in step 4120 may then execute the at least one converted machine-learning model on said node using data stored on said each node. All or some of the data stored on each node that executes the converted machine-learning model may be input to the machine-learning model. The data used as input to the converted machine-learning model may be specified by the orchestration system 210. The user request from the user device 220 to the orchestration system 210 in step 402 may instruct the orchestration system 210 to specify the data used as input to the converted machine-learning model.

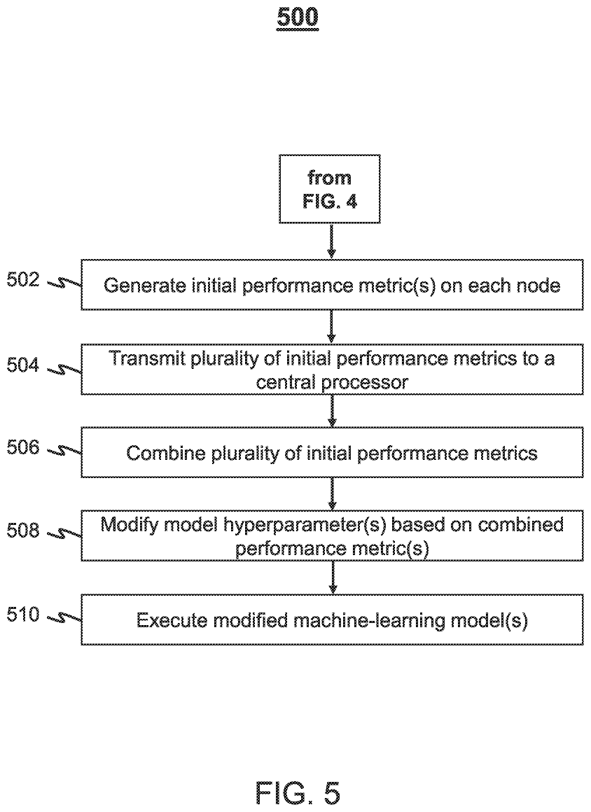

After the converted machine-learning model is executed on each node that received the converted machine-learning model, the method 400 may proceed to additional steps of method 500, depicted in connection with FIG. 5.

Referring now to FIG. 5, a flow diagram of a method 500 for distributed execution of a machine-learning model on a server cluster is shown, according to some non-limiting embodiments or aspects of the present disclosure. The method 500 may be performed by the model distribution management system 201, the model development system 202, the data repository 208, the orchestration system 210, the server cluster 212 (including one or more nodes 213a-213n thereof), the user device 220, and/or another computing device. One or more steps performed by a first processor may be performed by a same or different processor. The steps shown in FIG. 5 are for example purposes only. It will be appreciated that additional, fewer, different, and/or a different order of steps may be used in non-limiting embodiments or aspects. Method 500 may be read as a continuation of method 400, depicted in connection with FIG. 4.

In step 502, an initial performance metric may be generated on each node. For example, each node that executed the converted machine-learning model may generate one or more initial performance metrics on said node, based on execution of the at least one converted machine-learning model on said node. In doing so, the one or more nodes of the server cluster 212 may produce a plurality of initial performance metrics. The at least one initial performance metric generated on each node of the at least two nodes may include an error rate based on false positives and false negatives of the at least one converted machine-learning model. The plurality of initial performance metrics generated on one or more nodes of the server cluster 212 may be transmitted and/or retrieved from said nodes to the orchestration system 210.

In step 504, the plurality of initial performance metrics may be transmitted to a processor external to the server cluster. For example, each node of the at least two nodes of the server cluster 212 may transmit its respective initial performance metric(s) to a processor external to the server cluster, such as the orchestration system 210. Additionally or alternatively, the orchestration system 210 may transmit the plurality of initial performance metrics received from the at least two nodes of the server cluster 212 to a different processor external to the server cluster. The plurality of initial performance metrics may then be used to determine a combined (e.g., final) performance metric.

In step 506, the plurality of initial performance metrics may be combined. For example, the orchestration system 210 may combine the plurality of initial performance metrics received from the server cluster 212 to produce at least one combined performance metric for the at least one converted machine-learning model. The at least one combined performance metric may include, but is not limited to, AUROC, model sensitivity, model specificity, false positive rate, false negative rate, error rate, F-score, or any combination thereof. Combined performance metrics may indicate the overall performance of the evaluated machine-learning model, by which parameters (e.g., hyperparameters) of the machine-learning model may be adjusted to further improve the model.

In step 508, at least one model hyperparameter of the machine-learning model may be modified based on the at least one combined performance metric. For example, the orchestration system 210 may modify at least one model hyperparameter of the at least one machine-learning model based on the at least one combined performance metric, to produce at least one modified machine-learning model. The at least one model hyperparameter may include, but is not limited to, classification threshold, neural network topology, neural network size, learning rate, or any combination thereof. Hyperparameters may be correlated with performance metrics such that adjustments to the hyperparameters are intended to further improve the performance metrics when the machine-learning model is executed again, such as for further evaluation or in a production environment.

In step 510, the at least one modified machine-learning model may be executed. For example, the orchestration system 210 may execute the at least one machine-learning model in a computer system (e.g., implementation system 222) to evaluate real-time event data. It will be appreciated that execution may include initiating execution, or causing execution, of the at least one modified machine-learning model. The computer system may include, or be included in, system 200 or environment 100. Alternatively, the computer system may be separate from system 200 and environment 100. The real-time event data may include, but is not limited to, event data, such as transaction data, that is received and/or processed in real-time (e.g., in a live situation, such as a time at which or close to a time at which operations, such as operations of a transaction processing system or other system or device, are carried out) by a transaction processing system.

Although the disclosure has been described in detail for the purpose of illustration based on what is currently considered to be the most practical and preferred embodiments or aspects, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect, and one or more steps may be taken in a different order than presented in the present disclosure. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method comprising:
receiving, with at least one processor, a request identifying at least one machine-learning model;
initiating retrieval, with at least one processor, of the at least one machine-learning model from a data repository based on the request;
converting, with at least one processor, the at least one machine-learning model from an initial format to an executable format compatible with distributed execution on a server cluster, to produce at least one converted machine-learning model;
transmitting, with at least one processor, the at least one converted machine-learning model to each node of at least two nodes of the server cluster;
executing, with at least one processor, the at least one converted machine-learning model on each node of the at least two nodes using data stored on said each node;
generating, with at least one processor, an initial performance metric on each node of the at least two nodes based on execution of the at least one converted machine-learning model on each node of the at least two nodes, to produce a plurality of initial performance metrics;
transmitting, with at least one processor, the plurality of initial performance metrics from each node of the at least two nodes to a processor external to the server cluster;
combining, with at least one processor, the plurality of initial performance metrics to produce at least one combined performance metric for the at least one converted machine-learning model;
modifying, with at least one processor, at least one model hyperparameter of the at least one machine-learning model based on the at least one combined performance metric, to produce at least one modified machine-learning model; and
executing, with at least one processor, the at least one modified machine-learning model in a computer system to evaluate real-time event data.

2. The computer-implemented method of claim 1, wherein the request further comprises at least one data parameter associated with a subset of data stored in the server cluster, and wherein executing the at least one converted machine-learning model on each node of the at least two nodes further comprises inputting the subset of data stored on said each node to the at least one converted machine-learning model based on the at least one data parameter.

3. The computer-implemented method of claim 1, wherein converting the at least one machine-learning model to the executable format compatible with distributed execution in the server cluster comprises:
converting, with at least one processor, the at least one machine-learning model from the initial format that is based on a first machine-learning programming library to a new format that is based on a second machine-learning programming library different from the first machine-learning programming library.

4. The computer-implemented method of claim 3, further comprising determining, with at least one processor, the new format based on a programming language used to operate the server cluster.

5. The computer-implemented method of claim 1, wherein the initial performance metric generated on each node of the at least two nodes comprises an error rate based on false positives and false negatives of the at least one converted machine-learning model.

6. The computer-implemented method of claim 1, wherein the at least one combined performance metric comprises at least one of the following:
area under a receiver operating characteristic (AUROC);
model sensitivity;
model specificity;
false positive rate;
false negative rate;
error rate;
F-score; or
any combination thereof.

7. The computer-implemented method of claim 6, wherein the at least one model hyperparameter comprises at least one of the following:
classification threshold;
neural network topology;
neural network size;
learning rate; or
any combination thereof.

8. A system comprising at least one server comprising at least one processor, wherein the at least one server is programmed or configured to:
receive a request identifying at least one machine-learning model;
initiate retrieval of the at least one machine-learning model from a data repository based on the request;
convert the at least one machine-learning model from an initial format to an executable format compatible with distributed execution on a server cluster, to produce at least one converted machine-learning model;
transmit the at least one converted machine-learning model to each node of at least two nodes of the server cluster;
execute the at least one converted machine-learning model on each node of the at least two nodes using data stored on said each node;
generate an initial performance metric on each node of the at least two nodes based on execution of the at least one converted machine-learning model on each node of the at least two nodes, to produce a plurality of initial performance metrics;
transmit the plurality of initial performance metrics from each node of the at least two nodes to a processor external to the server cluster;
combine the plurality of initial performance metrics to produce at least one combined performance metric for the at least one converted machine-learning model;
modify at least one model hyperparameter of the at least one machine-learning model based on the at least one combined performance metric, to produce at least one modified machine-learning model; and
execute the at least one modified machine-learning model in a computer system to evaluate real-time event data.

9. The system of claim 8, wherein the request further comprises at least one data parameter associated with a subset of data stored in the server cluster, and wherein executing the at least one converted machine-learning model on each node of the at least two nodes further comprises inputting the subset of data stored on said each node to the at least one converted machine-learning model based on the at least one data parameter.

10. The system of claim 8, wherein converting the at least one machine-learning model to the executable format compatible with distributed execution in the server cluster comprises:
converting the at least one machine-learning model from the initial format that is based on a first machine-learning programming library to a new format that is based on a second machine-learning programming library different from the first machine-learning programming library.

11. The system of claim 10, wherein the at least one server is further programmed or configured to determine the new format based on a programming language used to operate the server cluster.

12. The system of claim 8, wherein the initial performance metric generated on each node of the at least two nodes comprises an error rate based on false positives and false negatives of the at least one converted machine-learning model.

13. The system of claim 8, wherein the at least one combined performance metric comprises at least one of the following:
area under a receiver operating characteristic (AUROC);
model sensitivity;
model specificity;
false positive rate;
false negative rate;
error rate;
F-score; or
any combination thereof.

14. The system of claim 13, wherein the at least one model hyperparameter comprises at least one of the following:
classification threshold;
neural network topology;
neural network size;
learning rate; or
any combination thereof.

15. A computer program product comprising at least one non-transitory computer-readable medium comprising program instructions that, when executed by at least one processor, cause the at least one processor to:
receive a request identifying at least one machine-learning model;
initiate retrieval of the at least one machine-learning model from a data repository based on the request;
convert the at least one machine-learning model from an initial format to an executable format compatible with distributed execution on a server cluster, to produce at least one converted machine-learning model;
transmit the at least one converted machine-learning model to each node of at least two nodes of the server cluster;
execute the at least one converted machine-learning model on each node of the at least two nodes using data stored on said each node;
generate an initial performance metric on each node of the at least two nodes based on execution of the at least one converted machine-learning model on each node of the at least two nodes, to produce a plurality of initial performance metrics;
transmit the plurality of initial performance metrics from each node of the at least two nodes to a processor external to the server cluster;
combine the plurality of initial performance metrics to produce at least one combined performance metric for the at least one converted machine-learning model;
modify at least one model hyperparameter of the at least one machine-learning model based on the at least one combined performance metric, to produce at least one modified machine-learning model; and
execute the at least one modified machine-learning model in a computer system to evaluate real-time event data.

16. The computer program product of claim 15, wherein the request further comprises at least one data parameter associated with a subset of data stored in the server cluster, and wherein executing the at least one converted machine-learning model on each node of the at least two nodes further comprises inputting the subset of data stored on said each node to the at least one converted machine-learning model based on the at least one data parameter.

17. The computer program product of claim 15, wherein converting the at least one machine-learning model to the executable format compatible with distributed execution in the server cluster comprises:
converting the at least one machine-learning model from the initial format that is based on a first machine-learning programming library to a new format that is based on a second machine-learning programming library different from the first machine-learning programming library.

18. The computer program product of claim 17, wherein the program instructions further cause the at least one processor to determine the new format based on a programming language used to operate the server cluster.

19. The computer program product of claim 15, wherein the at least one combined performance metric comprises at least one of the following:
area under a receiver operating characteristic (AUROC);
model sensitivity;
model specificity;
false positive rate;
false negative rate;
error rate;
F-score; or
any combination thereof.

20. The computer program product of claim 19, wherein the at least one model hyperparameter comprises at least one of the following:
classification threshold;
neural network topology;
neural network size;
learning rate; or
any combination thereof.
